(19) United States
(12) Patent Application Publication
(10) Pub. No.: US 2025/0382478 A1
(43) Pub. Date: Dec. 18, 2025

(54) Roof Restoration Coating

(71) Applicants: Robert Jenks, Pasadena, CA (US); Janelle Benedict, Los Angeles, CA (US)

(72) Inventors: Robert Jenks, Pasadena, CA (US); Janelle Benedict, Los Angeles, CA (US)

(21) Appl. No.: 19/069,065

(22) Filed: Mar. 3, 2025

Related U.S. Application Data
(60) Provisional application No. 63/661,495, filed on Jun. 18, 2024.

(51) Int. Cl. C09D 7/65; C09D 133/04; E04G 23/02

(52) U.S. Cl. CPC C09D 7/65; C09D 133/04; E04G 23/0281

(57) ABSTRACT

A roof coating material is provided which is formed of elastomeric coating material and a volume of particles which will not dissolve within said elastomeric coating material. The material forming the particles preferably has a specific gravity substantially equal to a specific gravity of the elastomeric coating material.

This application claims priority to U.S. Provisional Patent Application Ser. No. 63/661,495 filed on Jun. 18, 2024.

### FIELD OF THE INVENTION

The disclosed device relates to roofs of buildings, such as are located on businesses and homes. More particularly, it relates to an elastomeric coating for covering an existing shingled or other covering of such a roof, which restores both the waterproof functionality as well as the appearance of the existing roof.

### BACKGROUND OF THE INVENTION

Roof shingles are widely employed as a roof covering consisting of individual, overlapping shingle components. Such shingle components are typically flat rectangular shapes laid in courses from the bottom edge of the roof upward. During installation each successive course of shingles overlaps the joints below.

The shingles employed on roofs are held elevated on the bare roof surface by the roof rafters, and are manufactured from various materials, such as wood, slate, flagstone, metal, and plastic. Widely used because of durability and low cost are shingles formed of composite materials such as cement, fiber, and asphalt shingles. Over time, due to substantially direct exposure to sunlight, roof shingles may deteriorate faster and need to repel more water than vertically disposed wall shingles. They are a very common roofing material in the United States.

In the United States, fiberglass-based asphalt shingles are by far the most common roof covering employed for residential roofing applications. The protective nature of paper and fiberglass asphalt shingles primarily comes from the long-chain petroleum hydrocarbons. Over time in the hot sun such asphalt shingles tend to soften and when rain falls the oils are gradually washed out of the shingles. During rain, more water is channeled along eave locations and along complex rooflines, and these are subsequently more prone to erosion than other areas.

Eventually, the loss of the oils will cause asphalt shingle fibers to shrink and wood shingles to rot, exposing the nail heads under the shingles. Once these nail heads are exposed, water running down the roof can seep into the building around the nail shank, resulting in rotting of underlying roof building materials and causing moisture damage to ceilings and paint inside. Conventionally, the only long term remedy for a leaking roof is a replacement of the shingles and protective under layer forming it.

In this respect, before explaining at least one embodiment of the roof restoration coating system herein in detail, it is to be understood that the formed coating is not limited in its application to the details of construction and to the arrangement of the components set forth in the following description or illustrated in the drawings nor the steps outlined in the specification.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes for the coating restoration system and device disclosed herein. It is important, therefore, that the claims be regarded as including such equivalent construction insofar as they do not depart from the spirit and scope of the present invention.

### OBJECTS OF THE INVENTION

An object of this invention is the provision of a substantially elastomeric, acrylic, liquid coating in combination with polymeric particles, such as ABS or PVC, which upon application and curing upon an existing roof surface, will form a solid solution thereon, which restores both the appearance and water repelling functionality of the roof.

It is a further object of the invention herein to provide such a coating material wherein the plastic or polymeric particles mixed with the liquid coating have specific gravity substantially equal to that of the elastomeric material forming the coating to alleviate the need for mixing and stirring of the product during and prior to use.

An additional object of this invention is the provision of a coating for existing roof shingles, which will not require the removal and replacement of existing shingles.

Yet, a further object of this invention is the provision of a roof coating which is applicable to a roof using rollers or brushes, wherein a homeowner may apply it to their roof themselves without the need for a contractor.

These, together with other objects and advantages of the disclosed roof coating material and system herein, which will become subsequently apparent to those skilled in the art, reside in the details of the device construction and method herein as more fully hereinafter described and claimed, reference being had to the accompanying drawings forming a part thereof, wherein like numerals refer to like parts throughout.

### SUMMARY OF THE INVENTION

The system herein employs an elastomeric material for a coating configured for strong adherence to a substrate of choice, such as a roof top having shingles thereon, which includes a volume of particles mixed into the elastomeric coating. Preferably, in all configurations of the mixture of elastomeric material making up the coating and the material used for the particles, the specific gravity or specific density of the coating material is substantially equal to the specific gravity or specific density of the particles mixed therein.

The substantially equal specific gravity or specific density of both the elastomeric material with the mixed particles therein is preferred, because it substantially eliminates the need for mixing and shaking the elastomeric material once combined with the particles and during use thereafter. It also insures that the particles remain evenly distributed and situated within the elastomeric coating material once applied and until the coating cures to a solid solution of elastomeric material and particles.

For example only, and in no way to be considered limiting, the specific gravity of polyvinyl chloride particles (PVC) is around 1.1-1.4, which is heavier than many plastics, and the specific gravity of acrylonitrile butadiene styrene (ABS) particles may be 1.0-1.3.

As noted, preferably the material herein employed for covering or coating rooftops and the like is an elastomeric coating material. By elastomeric coating material herein is meant a coating made with polymers, or the like, which provide superior adherence and protection from corrosion to itself, and an underlying surface. In the process herein, the coating, as applied, is an elastomer material which adheres to a supporting substrate, such as the shingles on a rooftop. For example only, and in no way limiting, such elastomeric coatings herein can include one or a combination of elastomeric materials, from a group including acrylic (1.1-1.19 specific gravity), silicone (1.1-1.25 specific gravity), natural and synthetic rubber (0.9-1.4 specific gravity), urethane (1.1-1.2 specific gravity), epoxy (1.2-1.6 specific gravity), phenolic resins (1.2-1.6 specific gravity), and nitrocellulose (1.5-1.7 specific gravity). However, as noted, it is particularly preferred that the elastomeric material chosen for the elastomeric coating has a specific gravity substantially equal to the specific gravity of the material forming the non soluble particles mixed into the elastomeric coating. With regard to specific gravity, by substantially equal herein is meant, the specific gravity of the particles is equal to, or no more than, 10% above or below, the specific gravity of the elastomeric coating material into which it is mixed. By non-soluble herein is meant that the material forming the particles is such that, it will not dissolve in the material forming the elastomeric coating when positioned therein. The particles employed in the mixture with the chosen elastomeric coating herein include particles formed one or a combination of particle materials from a group of particle materials including: poly vinyl chloride (PVC), high density polyethylene, polypropylene, polycarbonate, ABS, glass and granite. Currently, due to a matching specific gravity to the material forming the elastomeric coating, PVC is a preferred particle material. Further, PVC has a flame spread index of 10-20, which when mixed into the elastomeric material and cured, maintains a class A fire rating to the coating once adhered to a roof and cured. Consequently, where a fire rating is desirable, PVC would be the preferred material forming the particles.

In the preferred mode of the system herein, the particles mixed with the elastomeric material forming the coating herein have a highly irregular shape, and a granule size substantially along a longest side being between 6 mm to 3 mm with a particularly favored size between. 4 mm and 5 mm. However, the particle size may be varied. By irregular shape herein is meant a multi-faced three-dimensional shaped particle forming a solid particle with sharp edges, where the faces on the exterior of the particles are substantially unequal in size or shape, meaning the sides and the angles of the particle shape vary, unlike a regular 3D shape such as a square or triangle or cube which have consistent faces with equal sides and angles. Sharp edges on the particles are also preferred.

A preferred mixture of particles to elastomeric material includes the 3-20% volume of particles to the total volume of the elastomeric material forming the mixed coating. For example only, and in no way limiting, in a total volume of five gallons of elastomeric material to be employed for a coating, there may be mixed therein in volume, between 19 ounces and 128 fluid ounces (4 quarts) of particles.

In all modes of the system herein, in order to best insure an irregular shape or the particles with sharp edges, the particles may be formed by grinding solid material into the granules using a plastic grinder or plastic granulator machine. It has been found in experimentation, that the random highly irregular shapes of particles, where the particles have sharp edges, which result from grinding solid portions of the particle material are particularly preferred.

This is because in experimentation the cohesion of the elastomeric material to irregular and multi-angled faces of such irregular sharp-edged granules was superior. Also from experimentation with the coating herein, such irregular 3D shapes also provide building block type structures, which will better fill in the cracks and other areas of damage and wear on the existing shingles of the roof being treated. This is especially true where the particles have a specific gravity substantially equal to that of the elastomeric material and evenly dispersed or distributed in the elastomeric material initially and once cured to a solid solution.

Once the elastomeric material has been mixed with the chosen amount of particles by volume, because the specific gravity of the material forming particles is substantially equal to the specific gravity of the material comprising the elastomeric coating mixture, the particles will tend to remain in suspension within the elastomeric material in a substantially equal distribution. This helps eliminate the sinking and clumping of the particles to uneven positions within the mixture, which occurs in other mixtures and substantially eliminates the need to shake or stir the mixed coating before and during use.

Additionally, the material forming the particles, such as PVC, can be ground from particle material, such as PVC possessing the same or similar color to the color of the elastomeric material. Such will allow for an even colorizing of the coating and the roof once cured. In an alternative mode of mixture, the particles might be formed of a color different than that of the elastomeric material, which will provide the roof with a coating having an iridescence, or a color variance, which will allow for more matching of color paint choices when painting the building having a roof coated by the material herein.

With the elastomeric material mixed with the particles noted herein in the preferred mixture rate by volume of elastomeric material, the formed coating material is applicable to the substrate, such as rooftop mounted shingles. The material is easy to apply with a simple roller or brushes, thereby rendering the mixture and the system herein an easy do-it-yourself project for homeowners, saving them thousands of dollars in cost from that of a new roof installed by roofing contractors.

With respect to the above description then, it is to be realized that the dimensional relationships and components of the roof restoration coating material and method herein may also include variations in size, materials, shape, form, function and manner of operation, manner of formation, assembly and use, which are deemed readily apparent and obvious to one skilled in the art subsequent to their review of this specification. Therefore, the foregoing summary, and following description, are considered as illustrative only of the principles of the invention to provide an easily employable roof coating material for restoration of both function and appearance of roofs.

Further, since numerous modifications and changes will readily occur to those skilled in the art subsequent to their review of this disclosure, it is not desired to limit the invention to the exact construction and operation and steps of formation and employment of the roof coating material and system shown and described. Accordingly, all suitable modifications and equivalents, which may be resorted to, are considered to fall within the scope of the invention.

### BRIEF DESCRIPTION OF THE DRAWINGS

The accompanying drawings, which are incorporated herein and form a part of the specification, illustrate some but not the only or exclusive examples of embodiments of the roof coating material and system herein providing both functional and appearance renewal. It is intended that the embodiments and figures disclosed herein are to be considered illustrative of preferred modes of the device and the system rather than limiting.

FIG. 1 shows a depiction of a typical roof covered with shingles which are in disrepair having holes and other defects therein.

FIG. 2 depicts a section of the roof of FIG. 1 wherein the coating material herein has been applied and cured to a portion of the roof to renew both the weatherproofing function and the appearance of the roofing materials.

FIG. 3 shows an enlarged view of the preferred irregular shape and sharp edges of the particles which are employed in combination with the elastomeric coating material of the mixture herein.

FIG. 4 shows the preferred mixture of particles with the elastomeric material showing the substantially even distribution of particles within the mixture where the particles and elastomeric material having a substantially equal specific gravity.

FIG. 5 depicts a sectional view through roofing shingles which are nailed in place in overlapping rows on an underlying roof and underlayment which shows a fully functional shingle structure.

FIG. 6 depicts the shingle formation of FIG. 5 wherein the shingles have aged and derogated to a point wherein cracks therein have formed gaps which provide a path for water entry to the underlayment and roof structure.

FIG. 7 depicts a sectional view through a shingle formation of overlapping shingles such as in FIG. 6 which has been treated with the coating herein.

### DETAILED DESCRIPTION OF THE INVENTION

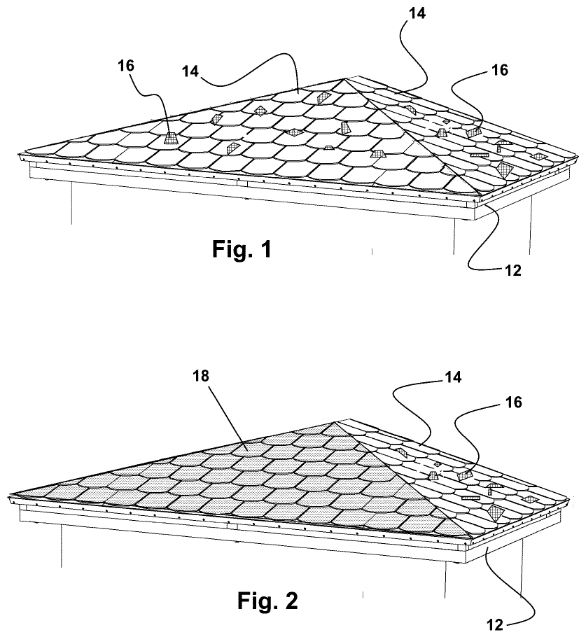

Referring now to the drawings in FIGS. 1-7, wherein similar components of the roof coating material and method are identified by like reference numerals. There is seen in FIG. 1, a depiction of a typical shingled roof 12, which has been first covered with an underlayment 13 (FIG. 5), such as synthetic fiber or felt over which shingles 14 have been placed in overlapping rows which are held to the roof by nails 17 (FIG. 5) or the like which are driven into the roof 12 and through the underlayment 13.

As shown in FIG. 1 and FIG. 6, the shingles 14 when they age are subject to degradation from sunlight, moisture, wind, and other environmental factors. Over time, such degradation can cause holes and other defects 16 to develop in the layers of shingles. These defects 16 provide pathways which expose the underlayment 13 and underlying layers of shingle material to sunlight and abrasion, as well as forming pathways for water to enter through and underneath the shingles 14 and the underlayment 13.

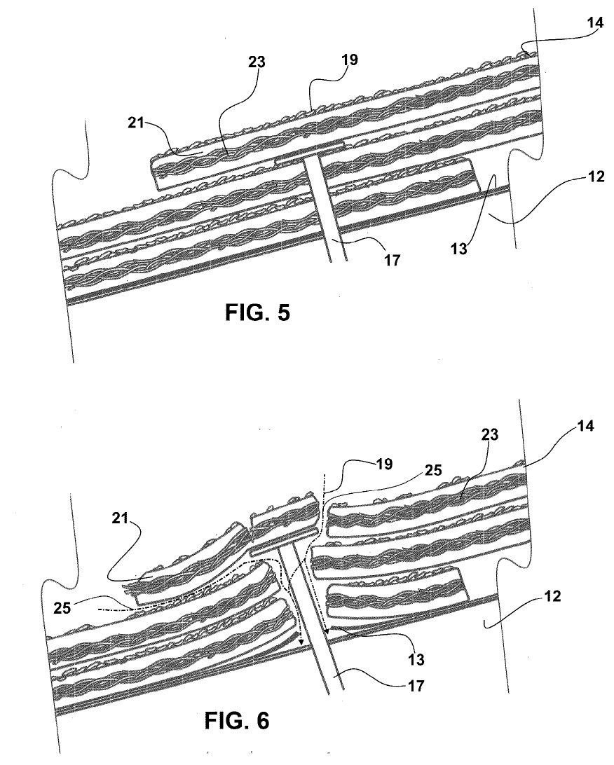

Shown in FIG. 2 is a section of the roof 12 of FIG. 1, wherein the coating material 18 herein described and disclosed has been applied to an area of the shingles 14 upon the roof 12. The elastomeric material 22, forming the coating material 18, adheres to the underlying shingles 14 and over, onto, and into the defects 16 therein. The coating material 18, once applied, will cure to form a solid solution which includes the elastomeric material 22 and the particles 20, as graphically depicted in a sectional view thereof in FIG. 4.

The elastomeric material 22, making up the majority of the coating 18, is adapted to adhere to the shingles 14 during the coating and curing process. Once cured, the mixture of elastomeric material 22 and particles 20 forms a coating 18 layer which renews both the function and the appearance of the shingles 14 by covering over holes and gaps in the layered shingle 14 structure.

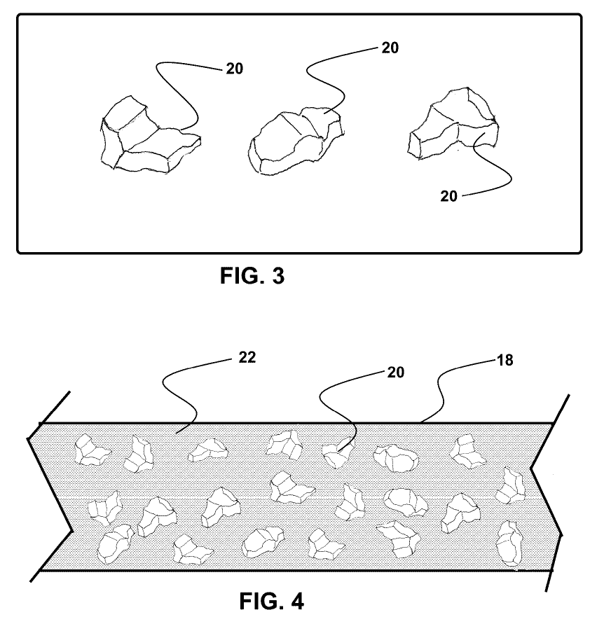

In FIG. 3 is depicted an enlarged view of the preferred particles which have an irregular shape and sharp edges on the faces of the particles 20, which are included in the coating 18 mixture. As noted above, it is preferred that the particles 20 are ground or otherwise formed from a plastic or polymeric material which has a substantially equal specific gravity to that of the elastomeric material 22 of the coating 18 mixture.

The result of the cured coating 18 mixture is depicted in a sectional view of a layer thereof, shown in FIG. 4. Due to the inclusion of particles 20 having a substantially equal specific gravity as the elastomeric material 22, forming the overall coating 18 mixture, the particles 20 tend to remain in place in the mixture, once applied, rather than falling to the lower area in clumps. As noted, such eliminates the need for any substantial stirring or shaking of the coating mixture during or prior to use. Further, since the particles 20 tend to stay in place in the mixture due to the substantially equal specific gravity of both the particles 20 and the elastomeric material 22, once the mixture cures to form the coating 18, the particles 20 will maintain a substantially even distribution throughout the solid solution forming the coating 18. Such insures a long life of the cured coating 18.

In a method of forming and use of the coating 18 herein, particles 20 formed of one or a combination of particle materials from a group of particle materials including poly vinyl chloride (PVC), high density polyethylene, polypropylene, polycarbonate, ABS, glass and granite are mixed with the elastomeric material 22 forming the coating 18. In the mixture, the elastomeric material includes one or a combination of elastomeric materials from an elastomeric group including acrylic, silicone, natural and synthetic rubber, urethane, epoxy, phenolic resins, and nitrocellulose.

Preferably, the particles 20 added to the elastomeric material 22, have a preferred granule substantially between 3 mm to 6 mm, with a particularly favored size of the unequal particles between 0.4 mm and 5 mm. Additionally preferred is forming the mixture of particles 20 with the elastomeric coating material 22 where the particles 20 added to the elastomeric material 22 have a substantially equal specific gravity as the elastomeric material 22 and include 3-20% of particles 20 to the total volume of the elastomeric material 22 forming the mixture coating 18. The resulting coating 18 mixture may be placed in containers, such as cans, which are sealed until the coating 18 mixture is to be applied to a surface, such as shingles 14, on an existing roof 12. The coating mixture 18 may later be taken from the sealed cans or containers and applied to the roof 12 using a roller or brush or sprayer to place a substantially even layer thereon. The coating 18 is then allowed to cure and adhere to the shingles 14 or rooftop layer to form a cured coating layer formed by a solid solution of elastomeric material 22 and particles 20.

For a reference of the long term degradation of conventional shingles, such as asphalt, fiberglass and similar conventional shingles, the depiction in FIGS. 5-6 show a sectional view through overlapping shingles 14 which are held to a roof 12 by roofing nails 17 driven through the tab of underlying shingles 14 and into the roof 12 which is formed of plywood or the like.

Shown in FIG. 5 is a sectional view through the tab portion of an underlying shingle 14 and through the underlayment 13 material and into the roof 12 material, such as plywood or other planar roof coverings. As shown, the shingles 14 are fully functional and the sand based particles 20 on such shingles 14 are in position to protect the underlying tar based material 21 and the fiberglass mat 23 from degradation from UV rays and moisture and weather.

In FIG. 6, a shingle 14 formation, such as in FIG. 5, wherein the overlaid shingles 14 have aged and derogated to a point where they have gaps or cracks 19 communicating through the body of the shingle 14. These cracks 19 along with the loosening of the nail 17 from engagement to the roof 12 material are a prime reason that gaps or cracks 19 are formed through the shingle structure. The gaps or cracks 19 form a path 25 for water entry through the overlaid shingles and to the underlayment 13 and roof 12 structure. Moisture, such as water, reaching the underlying roof 12 can cause significant damage to the roof 12, such as by rotting the wood forming the planar layer into which the shingles engage.

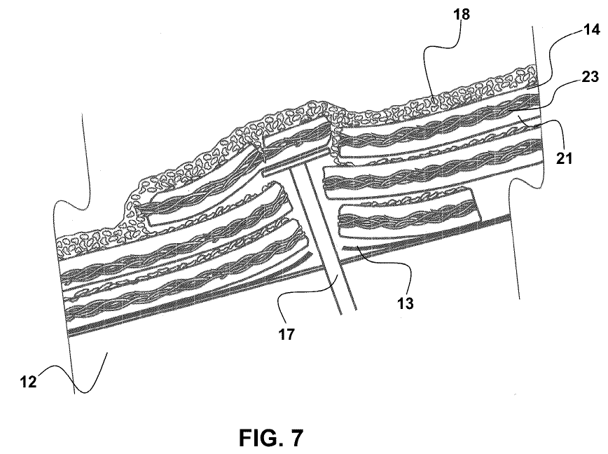

In FIG. 7 is shown the shingles 14 of FIG. 6 wherein the coating 18 herein has been applied and engaged with the shingles 14. The coating 18 has also formed a layer which prevents water and moisture entry into the underlying roof 12 through the cracks 19 and formed pathways 25 thereunder.

As noted above, while the present elastomeric roof coating material and system invention has been described herein with reference to particular embodiments thereof and steps in the method of employment of the modes thereof, a latitude of modifications, various changes and substitutions are intended in the foregoing disclosures. It will be appreciated that in some instances some features or steps in configuration of the elastomeric roof coating invention could be employed without a corresponding use of other features without departing from the scope of the invention as set forth in the following claims. All such changes, alterations, and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art who are not familiar with patent or legal terms or phraseology, to determine quickly from a cursory inspection, the nature and essence of the technical disclosure of the application. Any such abstract is neither intended to define the invention of the application, which is measured by the claims, nor is it intended to be limiting, as to the scope of the invention in any way.

What is claimed is:

1. A roof coating material comprising:
a volume of elastomeric coating material; and
a volume of particles which is 3-20% said volume of elastomeric material, said particles formed of a particle material which will not dissolve within said elastomeric coating material.

2. The roof coating material of claim 1 wherein said volume of elastomeric coating material is one or a plurality of elastomeric materials, from a group of elastomeric materials including, acrylic, silicone, natural and synthetic rubber, urethane, epoxy, phenolic resins, and nitrocellulose.

3. The roof coating material of claim 1 wherein a particle specific gravity of said particles is substantially equal to an elastomeric specific gravity of said elastomeric coating material.

4. The roof coating material of claim 2 wherein a particle specific gravity of said particles is substantially equal to an elastomeric specific gravity of said elastomeric coating material, wherein said particles are equally distributed in said elastomeric coating when it has cured to a solid solution.

5. The roof coating material of claim 1 wherein said particles are formed with multi-angled irregular exterior surfaces thereon.

6. The roof coating material of claim 2 wherein said particles are formed with multi-angled irregular exterior surfaces thereon.

7. The roof coating material of claim 3 wherein said particles are formed with multi-angled irregular exterior surfaces thereon.

8. The roof coating material of claim 4 wherein said particles are formed with multi-angled irregular exterior surfaces thereon.

9. A method of positioning a layer of coating material upon a roof using the coating material of claim 4 comprising the steps of:
placing said coating material upon a brush or roller; and
employing said brush or roller to apply said coating layer to said roof.

10. A method of mixing a roof coating material for positioning atop a roof, comprising:
measuring a first volume of elastomeric coating material; and
measuring a second volume of particles having a specific gravity substantially equal to that of said elastomeric material, which second volume is 3-20% said volume of elastomeric material; and
mixing said second volume into said first volume to thereby form said roof coating material.
